(19) United States
(12) Patent Application Publication
(10) Pub. No.: US 2013/0015335 A1
(43) Pub. Date: Jan. 17, 2013

(54) DEVICE AND METHOD FOR ATTACHING PROTECTIVE FILM TO AND REMOVING PROTECTIVE FILM FROM LIGHT GUIDE PLATE

(71) Applicants: TAI-CHERNG YU, Tu-Cheng (TW); DA-WEI LIN, Tu-Cheng (TW)

(72) Inventors: TAI-CHERNG YU, Tu-Cheng (TW); DA-WEI LIN, Tu-Cheng (TW)

(73) Assignee: HON HAI PRECISION INDUSTRY CO., LTD., Tu-Cheng (TW)

(21) Appl. No.: 13/450,495

(22) Filed: Apr. 19, 2012

(30) Foreign Application Priority Data
Jul. 12, 2011 (TW) 100124664

(51) Int. Cl. G01J 5/08

(52) U.S. Cl. 250/227.14

(57) ABSTRACT

A device includes a first roller to roll down a protective film around the first roller, a conveying device to convey a light guide plate (LGP), and a first fan to generate charged ions and blow out the charged ions. While the rolled-down protective film is being placed onto the LGP being conveyed by the conveying device, the charged ions blown out by the first fan are adhered to a first surface of the protective film to generate static electricity and the first surface of the protective film is attached to the LGP by the static electricity.

### BACKGROUND

1. Technical Field

The present disclosure relates to a device and method for attaching a protective film or removing the protective film, particularly to a device and method for attaching the protective film to a light guide plate (LGP) and removing the protective film from the LGP.

2. Description of Related Art

As a precision optical element, the LGP has an important function and needs good protection. After the LGP is manufactured, a protective film is needed to be attached to two surfaces of the LGP to protect the surfaces from being damaged. Generally, the protective film is glued to the LGP. When the protective film is removed from the LGP, the glue may remain on the surface of the LGP causing stains, which can make the LPG look dirty. Furthermore, the protective film should be removed manually from the LPG, thus the LGP may be easily damaged resulting in low efficiency.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of a device for attaching a protective film to an LGP and removing the protective film from the LGP in accordance with an exemplary embodiment.

FIG. 2 is an isometric view of the device of FIG. 1 to attach the protective film to a LGP.

FIG. 3 is an isometric view of the device of FIG. 1 to remove the protective film from a LGP.

### DETAILED DESCRIPTION

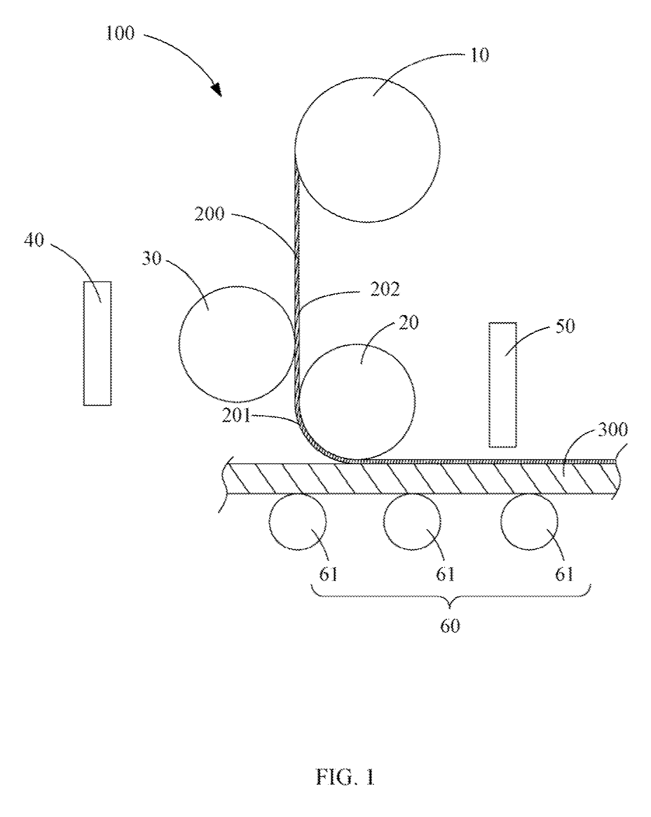

FIG. 1 is a schematic diagram of a device 100 for attaching a protective film 200 to an LGP 300 and removing the protective film 200 from the LGP 300 in accordance with an exemplary embodiment. The device 100 includes a first roller 10, a second roller 20, a third roller 30, a first fan 40, a second fan 50, and a conveying device 60. The first roller 10 is for rolling up or rolling down the protective film 200 around the first roller 10. The second roller 20 and the third roller 30 respectively contact two surfaces, namely a first surface 201 and a second surface 202, of the protective film 200. The first fan 40 and the third roller 30 are located on one side of the protective film 200. The second fan 50 and the first roller 20 are located on the other side of the protective film 200. The first fan 40 and the second fan 50 are used to generate positive charged ions or negative charged ions according to user's requirement and blow out the generated positive charged ions or negative charged ions. In the embodiment, the charged ions generated by the first fan 40 are blown to the third roller 30 and the charged ions generated by the second fan 50 are blown to the second roller 20. The charged ions generated by the first fan 40 also can be blown to the protective film 200 directly.

The conveying device 60 is used to convey the LGP 300 during the attachment of the protective film 200 to the LGP 300 or while removing the protective film 200 from the LGP 300. The conveying device 60 includes a number of conveying rollers 61 which are arrayed in horizontal direction. The LGP 300 is placed onto the number of conveying rollers 61. One end of the protective film 200 is placed onto the LGP 300. In the embodiment, the number of the conveying rollers 61 is three. The conveying rollers 61 are covered by a conveying belt (not shown) and the LGP 300 is placed onto the conveying belt. In the embodiment, the first roller 10, the second roller 20, the third roller 30, and the conveying rollers 61 are driven by a motor (not shown).

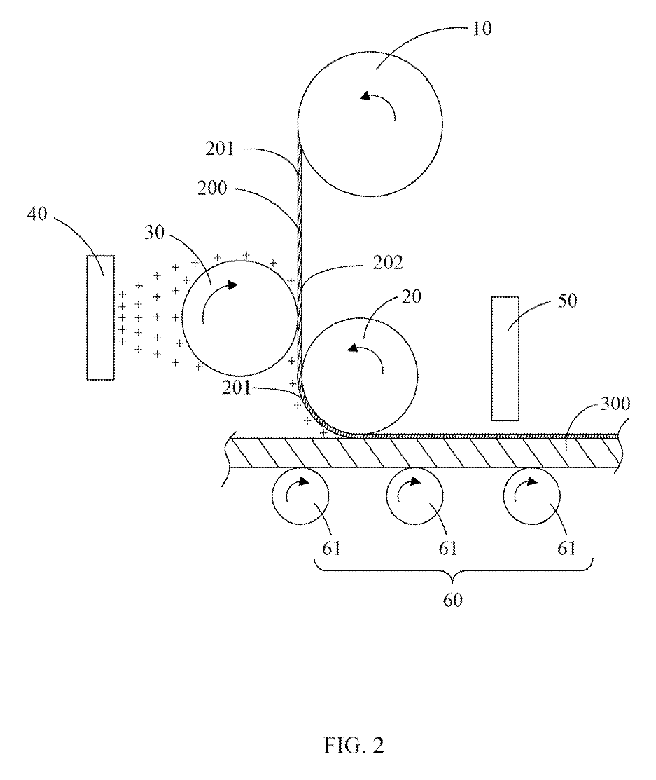

Referring to FIG. 2, when the device 100 is powered to attach the protective film 200 to the LGP 300, the first roller 10 and the second roller 20 are rolled anti-clockwise and the third roller 30 is rolled clockwise to roll down the protective film 200 which is previously rolled around the first roller 10 to the LGP 300. The first fan 40 blows out the positive charged ions to the third roller 30. The positive charged ions are transferred to the first surface 201 of the protective film 200 by the rolling of the third roller 30 to make the protective film 200 generate static electricity. When the protective film 200 is moved to contact the LGP 300, the first surface 201 of the protective film 200 is attached to the LGP 300 by the static electricity. The conveying rollers 61 are rolled anti-clockwise to convey the LGP 300 to be continually attached by the protective film 200. In other embodiments, the first fan 40 can directly blow out the charged ions to the protective film 200 to make the charged ions directly adhere to the protective film 200.

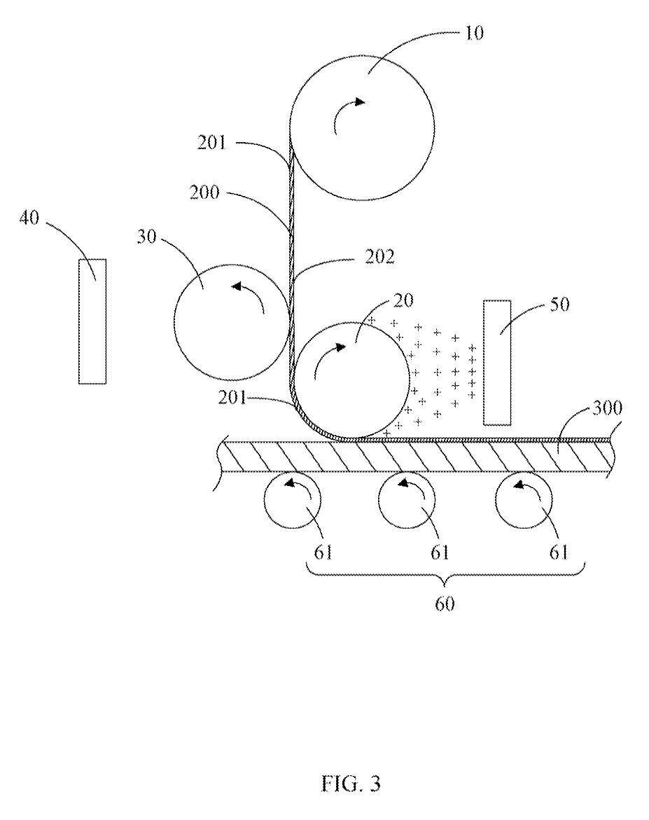

FIG. 3 is a schematic diagram for removing the protective film 200 from the LGP 300. The LGP 300 attached by the protective film 200 is placed onto the conveying device 60. A part of the protective film 200 which is not attached to the LGP 300 is previously rolled around the first roller 10. The first roller 10, the second roller 20, and the conveying rollers 61 are rolled clockwise and the third roller 30 is rolled anti-clockwise to remove the protective film 200 from the LGP 300 and roll up the removed protective film 200 to the first roller 10. The second fan 50 blows positive charged ions to the second roller 20 to make the second roller 20 generate static electricity. When being moved to the second roller 20, the protective film 200 is adhered to the second roller 20 due to the static electricity on the second roller 20, which makes the protective film 200 easily be removed from the LGP 300.

In other embodiment, when attaching the protective film 200 to the LGP 300, the second fan 20 blows negative charged ions to the second roller 20. The negative ions are transferred from the second roller 20 to the second surface of the protective film 200. The second roller 20 and the LGP 300 are kept at a distance, which is greater than the thickness of the protective film 200, not allowing the second roller 20 to make contact with the second surface 202 of the protective film 200 before the protective film 200 is removed from the LGP 300. Thereby, when the protective film 200 is removed from the LGP 300, due to the negative charged ions on the protective film 200 and the positive charged ions on the second roller 20 do not contact before the protective film 200 is removed from the LGP 300, an adhering force is generated to allow the protective film 200 to be easily removed from the LGP 300. After the protective film 200 is removed from the LGP 300, the protective film 200 contacts the second roller 20, thus the negative charged ions on the protective film 200 and the positive charged ions on the second roller 20 are counteracted to remove the static electricity on the protective film 200.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A device comprising:
a first roller to roll down a protective film around the first roller;
a conveying device to convey a light guide plate (LGP);
a first fan to generate charged ions and blow out the charged ions;
wherein, while the rolled-down protective film is being placed onto the LGP being conveyed by the conveying device, the charged ions blown out by the first fan are adhered to a first surface of the protective film to generate static electricity and the first surface of the protective film is attached to the LGP by the static electricity.

2. The device as described in claim 1, wherein the first fan directly blows the charged ions to the first surface of the protective film.

3. The device as described in claim 1, wherein the charged ions generated by the first fan is positive ions.

4. The device as described in claim 1, further comprising a second roller for contacting the first surface of the protective film, wherein the first fan blows the charged ions to the second roller, the second roller is rolled to transfer the charged ions to the first surface of the protective film.

5. The device as described in claim 4, further comprising a third roller in contact with a second surface, opposite to the first of the protective film which is not attached to the LGP.

6. The device as described in claim 1, wherein the conveying device comprises a plurality of conveying rollers which are arrayed in horizontal direction.

7. The device as described in claim 6, wherein the number of the conveying rollers are three.

8. The device as described in claim 1, further comprising:
a second roller for contacting a second surface, opposite to the first of the protective film which is not attached to the LGP;
a second fan for blowing charged ions to the third roller;
wherein, in removing the protective film from the LGP, a part of the protective film which is not attached to the LGP is previously rolled around the first roller, the first roller is rolled to roll up the protective film from the LGP to the first roller, the third roller is rolled to transfer the charged ions to the second surface of the protective film to remove the protective film from the LGP.

9. The device as described in claim 8, further comprising a third roller, wherein the third roller contacts the first surface of the protective film, the second roller and the third roller are rolled simultaneously to roll up the protective film from the LGP to the first roller.

10. The device as described in claim 8, wherein the second roller and the LGP are kept at a distance, which is greater than the thickness of the protective film, not allowing the third roller to contact the protective film before the protective film is removed from the LGP, while the protective film is attached to the LGP, the second fan blows negative charged ions to the third roller, the negative charged ions are transferred from the third roller to the protective film, while the protective film is removed from the LGP, the second fan blows negative charged ions to the third roller.
